(19) United States
(12) Patent Application Publication
(10) Pub. No.: US 2006/0076769 A1
(43) Pub. Date: Apr. 13, 2006

(54) Musical information display and communication system and method

(76) Inventor: Leslie Chase, New York, NY (US)

Correspondence Address: RAYMOND J. WERNER, 2056 NW ALOCLEK DRIVE, SUITE 314, HILLSBORO, OR, 97124, US

(21) Appl. No.: 10/965,285

(22) Filed: Oct. 13, 2004

(51) Int. Cl. B42D 1/00

(52) U.S. Cl. 281/21.1

(57) ABSTRACT

Methods and apparatus for the display and communication of musical information that are well suited for musical instruction, and for group playing include a plurality of removably attachable glyph substrates, each glyph substrate having an imaging surface and an attachment surface; and a display structure upon which the glyph substrates may be removably attached. In one aspect of the invention, a first portion of the of glyph substrates have imaging surfaces pre-printed with chords or notes, a second portion of the glyph substrates have imaging substrates pre-printed with grids but without graphical symbols; and a third portion of the glyph substrates may have imaging substrates that are blank. In another aspect of the invention, the display structure has an erasable writable surface. In another aspect of the invention, a carrying case, specially adapted for storing and transporting the glyph substrates and display structure is provided.

### FIELD OF THE INVENTION

The present invention relates generally to the display and communication of musical information, and more particularly relates to the storage and use of removably attachable musical glyphs defining chords for one or more musical instruments.

### BACKGROUND

Musical information can be communicated in a number of formats. One very well known means of communicating musical information utilizes the conventional musical staff, with each horizontal line representing a particular musical note of a musical scale, and notations on the staff, specifying the order in which particular notes are to be played, and the length of time that each note is to be played. This scheme has been generally effective for the writing and reading of musical information.

Some people have found the requirement to “read” music, as described above, to be a difficult skill to acquire. Consequently, their interest in learning to play one or more musical instruments is diminished.

In view of these difficulties other schemes have been developed in order to provide, in an easier to read, or understand, format, the information required to play a particular piece of music on one or more musical instruments.

What is needed are methods and apparatus for the convenient storage, transportation, display, and communication of musical information that is particularly suited for musical instruction and/or group playing.

### SUMMARY OF THE INVENTION

Briefly, methods and apparatus for the display and communication of musical information are provided. Such methods and apparatus are well suited for musical instruction, and for group playing.

Various embodiments of the present invention include a plurality of removably attachable glyph substrates, each glyph substrate having an imaging surface and an attachment surface; and a display structure upon which the glyph substrates may be removably attached.

In a further aspect of the present invention, a first portion of the plurality of glyph substrates may have imaging surfaces that are pre-printed with chords or notes, a second portion of the glyph substrates may have imaging surfaces that are pre-printed with grids but without any graphical symbols; and a third portion of the glyph substrates may have imaging surfaces that are blank.

In a still further aspect of the present invention the display structure has an erasable writable surface.

In a still further aspect of the present invention, a carrying case, specially adapted for storing and transporting the glyph substrates and display structure is provided.

### BRIEF DESCRIPTION OF THE DRAWINGS

FIG. 1 illustrates a closed carrying case in accordance with the present invention.

FIG. 2 illustrates an open carrying case, in accordance with the present invention, showing pockets adapted to receive and store picks, erasers, pens, and a display board, and further showing a ring binder adapted to receive and hold pocket pages.

FIG. 3 illustrates a set of pocket pages, bound along a common edge, and having a row of holes disposed near the common edge, the holes being sized and spaced such that the holes can be aligned with, and engaged by, the rings of the ring binder of the carrying case so as to retain the pocket pages in the carrying case.

FIG. 4 illustrates a foldable display board.

FIG. 5 is similar to FIG. 2, except that this figure shows the pens, picks, erasing cloth, pocket pages, and display board, stowed in the carrying case in accordance with the present invention.

FIG. 6 illustrates the display board with several glyph substrates attached to the display board, the attached glyph substrates each having a glyph imaging surface that is pre-printed, and further showing writing on the display board providing additional information for playing a song.

FIG. 7 is a side view of the display board with a fold-out stand that is used to support the display board in a standing position.

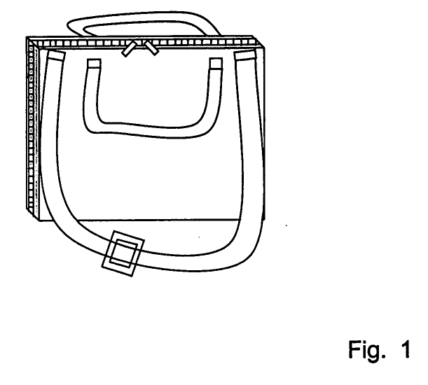

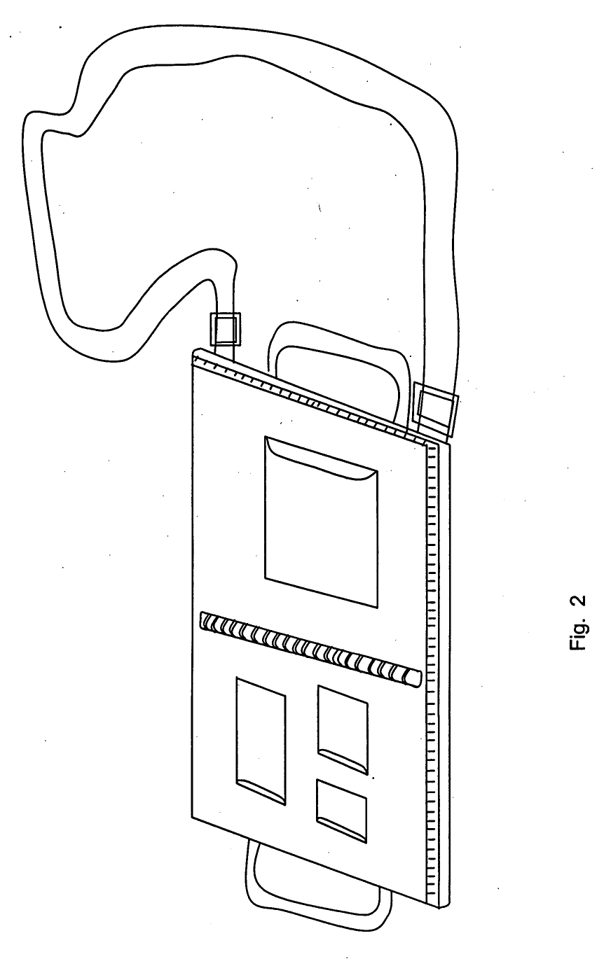

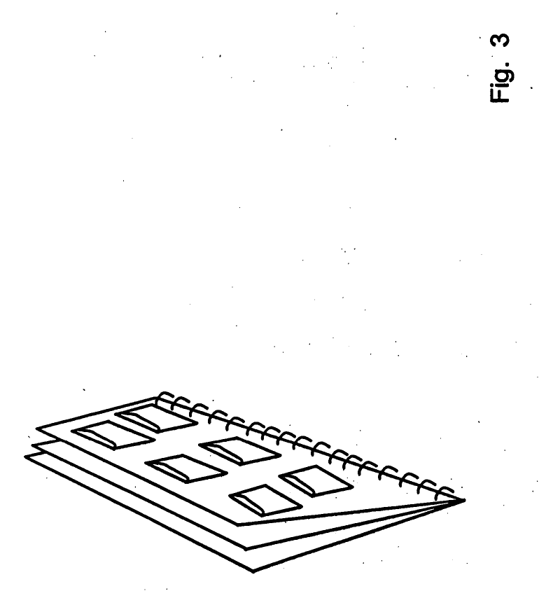

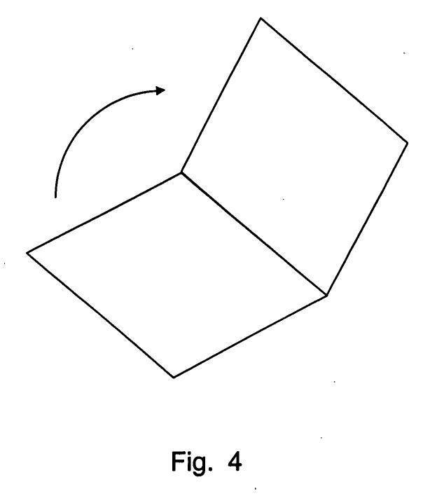

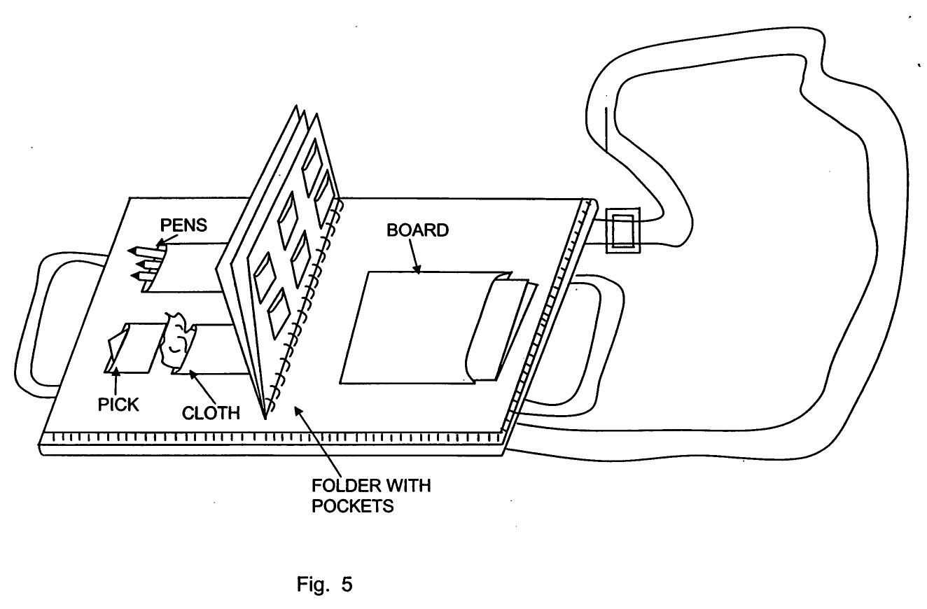

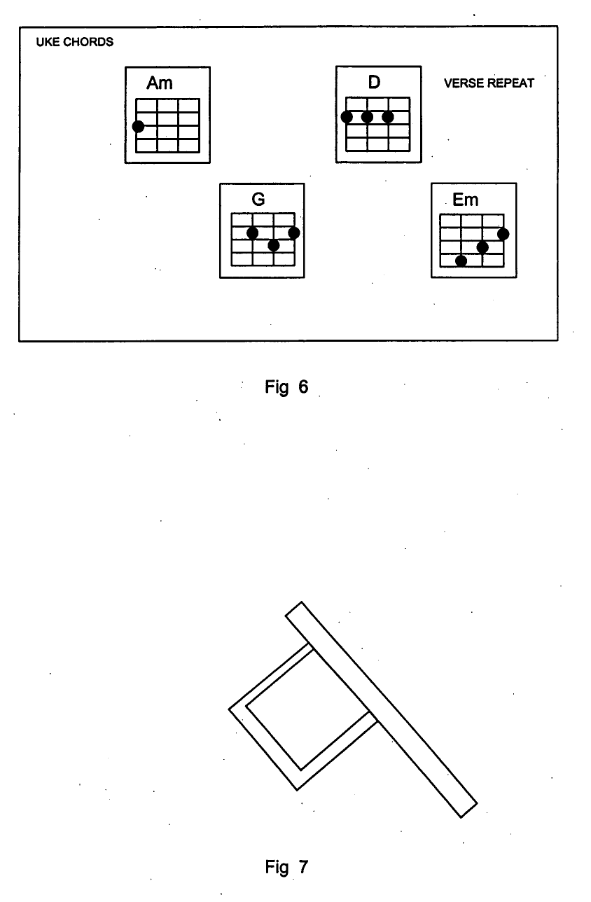

### DETAILED DESCRIPTION

Embodiments of the present invention can be used as a learning tool, or simply for personal enjoyment. As set forth in greater detail below, embodiments of the present invention may be used to teach chords, play songs, or to compose music or write songs.

Reference herein to “one embodiment”, “an embodiment”, or similar formulations, means that a particular feature, structure, operation, or characteristic described in connection with the embodiment, is included in at least one embodiment of the present invention. Thus, the appearances of such phrases or formulations herein are not necessarily all referring to the same embodiment. Furthermore, various particular features, structures, operations, or characteristics may be combined in any suitable manner in one or more embodiments.

For stringed instruments such as guitar or ukulele, a notational scheme for communicating musical information has been developed. In this scheme, a grid is provided in which each one of a plurality of vertical lines represent a corresponding one of a plurality of strings on the neck of the stringed instrument; in which each pair of the horizontal lines represents the boundaries of a corresponding one of a plurality of frets on the neck of the stringed instrument; and in which a graphical symbol, e.g., a dot, placed on a vertical line and between two horizontal lines, indicates coordinates, i.e., string and fret, where one of the musician's fingers is to be placed. In this notational scheme, the grids are referred to as glyphs.

A single graphical symbol present on the grid represents a single musical note (ignoring any harmonics that may be generated by the playing of the single string on that particular instrument). Several graphical symbols present together on the grid represent notes that are to be played concurrently, which is typically referred to as playing a chord.

Terminology

Glyph, as noted above, refers to a grid in which vertical lines typically represent strings on a stringed instrument, and horizontal lines typically represent fret boundaries on the neck of the stringed instrument. As used herein, glyph further denotes textual or symbolic representation of musical information.

Glyph substrate refers to a base, formed from any suitable material, that has two major surfaces. One of the two major surfaces is an attachment surface, and the other of the two major surfaces is the imaging surface.

Glyph imaging surface refers to the surface of the glyph substrate that contains pre-printed or user-supplied information.

Glyph attachment surface refers to the surface of the glyph substrate that faces a display structure, when the glyph substrate is removably attached to the display structure.

Blank glyph refers to a glyph imaging surface upon which no pre-printed information is provided. Such an imaging surface is typically adapted to be erasably written upon.

Chord glyph refers to a glyph imaging surface upon which is provided the information required to specify the playing of a predetermined musical chord on a predetermined instrument.

Display structure refers to a structure upon which one or more glyphs are removably attached to a display surface, and which further supports direct user writing on the display surface.

Package refers to a set of elements including, at least, glyph substrates, a display structure, and a carrying case adapted to conveniently stow the glyph substrates and the display structure.

Glyphs are used, among other things, to teach people to play chords on instruments such as a guitar, a banjo, or a ukulele. A tool in accordance with the present invention enables users to see the chords in a large format, thereby allowing them to play more easily. Such an arrangement also facilitates simultaneous use by multiple users.

Various embodiments of the present invention include a plurality of glyph substrates, each glyph substrate having at least a first major surface (referred to herein as the attachment surface) adapted to be removably attached to a display surface of a display structure, and a second major surface (referred to herein as the image surface, or imaging surface) adapted to have one or more glyphs imaged thereon. Such glyph images represent commonly used chords, for example, major, minor, seventh, diminished, and so on.

In various embodiments of the present invention, the imaging surface of the blank glyphs may include pre-printed vertically oriented lines that are representative of the number of strings on a particular musical instrument, such as, but not limited to, a guitar, a banjo, or a ukulele. In further embodiments, the blank glyphs may include pre-printed horizontally oriented lines that are representative of a number of frets, which may define some or all, of the frets found on a corresponding musical instrument.

In one illustrative embodiment, the glyph imaging surface includes a label, that identifies a note or a chord that is specified by the placement of one or more graphical symbols (e.g., dots) on a grid. Such a label may be placed on a portion of the imaging surface that is outside a region bounded by the vertical and horizontal lines. In an alternative embodiment, the label may be placed on the imaging surface such that the vertical and horizontal lines appear to be overlaid thereon.

In one illustrative embodiment, a number of glyph substrates, each having a blank writable image surface are further included. The writable image surface is preferably constituted such that it is also erasable.

The imaging surface of a blank glyph substrate is typically adapted for use with erasable inks. In alternative embodiments, the imaging surface of the glyph substrates may be adapted to receive magnetic dots, or other graphical symbols.

Removable attachment of glyph substrates to a display surface of a display structure may be obtained by any suitable means, including but not limited to, magnetic attachment, adhesive attachment, snap-in attachment, velcro-like attachment, and so on.

In one embodiment, the display structure has a writable display surface disposed over a material to which a glyph substrate can be removably attached by magnetic force. In one such an embodiment, the glyph substrates are magnetized. The writable surface of the display support structure is preferably constituted such that it is also erasable.

In one embodiment, a carrying case is provided that is specially adapted to stow the glyphs, markers, picks, erasers, chord books, display structure, and so on, that are used for musical instruction, practice, or simply playing for enjoyment. Inside the carrying case, folder pages, alternatively referred to as “pocket pages”, are provided. The folder pages have pockets to hold the glyph substrates. The folder pages are removable. The glyph substrates are stored in the individual pockets of the folder pages, and the name of the chords is provided on the cover of each pocket. The folder pages are attached to each other along a common edge. The folder pages may include a plurality of holes therethrough, the holes typically being aligned in a row, and the row disposed near the common edge along which the folder pages are attached. The carrying case may include a ring binder such that the rings of the ring binder and the holes of the folder pages may be used in conjunction with each other to removably fasten the folder pages to the carrying case. It is noted that the pocket pages may be bound together and removably attached to the carrying case by any suitable means. For example, the pockets pages may be connected to each other by a spiral binder, and the spiral binder removably attached to the carrying case by means of a rod, or dowel, that is in turn clamped to the carrying case.

The carrying case may further include pockets for the erasable ink pens, or markers, of various colors. The carrying case may further include at least one pocket for picks that are used to play stringed instruments, such as but not limited to, guitars, banjos, and ukuleles. The carrying case may further include at least one pocket for a cleaning cloth, or eraser, which is used to wipe off the erasable ink from the display board and/or the blank glyphs. The carrying case may include a pocket for magnetic dots that are removably attachable to at least one glyph imaging surface and/or the display surface of the display structure. The carrying case may further include a pocket for a container of cleaning fluid, which is used to facilitate the removal of the erasable ink from the display board and/or the blank glyphs. The carrying case may further include a pocket for storing the display structure. Alternatively, the carrying case may include restraints, such as but not limited to elastic straps, for holding the display structure. Such elastic straps may also be used to hold other items, such as but not limited to, the color markers, the cleaning fluid container, and the eraser.

The carrying case may further include handles and/or shoulder straps to facilitate transportation thereof. The handles and/or the shoulder strap may be removable from the carrying case. The carrying case may further include a warning label advising that the case not be placed near devices that are sensitive to magnetic fields.

In an illustrative package in accordance with the present invention, glyphs are used to teach people guitar/ukulele chords in a large format allowing them to play more easily. This is also good for more than one player at a time.

The illustrative package contains magnetized glyphs of the most often used chords: major, minor, seventh, diminished, and so on. A typical package contains a number of blank glyphs, which a player may write upon using an erasable ink. These can be used for chords that are not included with the package. These can also be used for chords that repeat in a song, such that displaying the song requires more of a particular chord glyph than is supplied with the package. A chord book may be included in the package.

A display structure, or board, having a surface that accommodates erasable ink markers, is provided with the package. In one embodiment, the display structure includes a built-in pop-up stand on a back side thereof. In various embodiments the display structure itself folds such that it fits within a pocket in the carrying case.

In one embodiment, a package includes magnetized/erasable ink board and marker pens; magnetized glyphs with a variety of chords for a particular instrument; blank glyphs for use with erasable ink; a canvas bag for storage; and a chord book. Additional packages with blank glyphs only may be sold separately. Similarly, sets of chord glyphs for different instruments may be purchased separately. For example, in this way, chord glyphs for ukulele can be added to a package that originally contained only guitar chord glyphs.

Other Musical Information

In addition to specifying single notes and chords with the glyphs described above, it will be appreciated that other musical information may be communicated to a musician. For example, indications of time signatures, tempo, and rests, may be required to properly communicate to the musician the information needed to correctly play a song. For these purposes, glyph substrates with imaging surfaces pre-printed with the required text and/or symbols may be provided with a package in accordance with the present invention.

In alternative embodiments, glyph substrates with blank imaging surfaces may be provided so that a user may mark upon those imaging surfaces any other musical information required for a particular musical composition. It is noted that not all glyphs are required to be of uniform dimension. In some embodiments of the present invention, specially sized blank glyphs are provided upon which musical information requiring either more or less space than is required to specify a chord for a particular instrument, is written. For example, the width of a glyph substrate for a rest symbol may be less than that of a chord glyph, whereas the width of glyph substrate for a text message, such as “repeat” or “chorus”, may be greater than that of a chord glyph.

Conclusion

Methods and apparatus for the storage, transportation, display, and communication of musical information in general, and for musical instruction in particular, have been described herein.

Although the present invention is described in terms of glyphs for stringed instruments (e.g., guitar, ukulele, banjo, etc.), it is noted that glyphs for other instruments can be similarly used. For example, piano chords may be illustrated with appropriate glyphs indicating the keys, rather than the strings to be used.

One advantage of embodiments of the present invention is that an instructor and student can simultaneously view a large format set of glyphs.

Another advantage of embodiments of the present invention is that chord glyphs for different instruments can be simultaneously displayed on the same display structure.

Another advantage of embodiments of the present invention is that pre-printed chord glyphs can be combined with user-supplied chord glyphs.

Another advantage of embodiments of the present invention is that removably attachable chord glyphs can be combined with user-supplied musical information written directly on the display structure.

Another advantage of embodiments of the present invention is that the glyphs, and ancillary equipment such as markers, erasers, and picks can be conveniently stowed in the carrying case that is adapted to receive and hold those elements in labelled pockets for easy storage and retrieval, as well as transportation.

It is to be understood that the present invention is not limited to the embodiments described above, but encompasses any and all embodiments within the scope of the subjoined claims and their equivalents.

What is claimed is:

1. A system for displaying and communicating musical information, comprising:
a plurality of removably attachable glyph substrates, each glyph substrate having an imaging surface and attachment surface; and
a display structure having a display surface adapted to receive the attachment surface of the plurality of glyph substrates for removable attachment, the display surface being erasably writable.

2. The system of claim 1, wherein a first portion of the plurality of glyph substrates each have an imaging surface pre-printed with a grid and at least one graphical symbol representative of a musical note, a second portion of the plurality of glyph substrates each have an imaging surface pre-printed with a grid but without any graphical symbols; and a third portion of the glyph substrates each have an imaging surface that is blank.

3. The system of claim 2, wherein the third portion of the glyph substrates each have an erasable writeable imaging surface.

4. The system of claim 1, wherein the display structure is hinged for folding.

5. The system of claim 4, wherein the display structure comprises a support stand.

6. The system of claim 5, further comprising a carrying case having a first pocket adapted to receive and store the display structure, a second pocket adapted to receive and store at least one marker, a third pocket adapted to receive and store an eraser, and a ring binder adapted to received and hold at least one pocket page, the at least one pocket page adapted to receive and store a plurality of glyph substrates.

7. The system of claim 6, wherein the carrying case further comprises handles, shoulder straps, and a warning label regarding magnetic proximity.

8. The system of claim 7, further comprising at least one pocket page held in place by the ring binder, the pocket page having at least one pocket; and wherein the plurality of removably attachable glyph substrates are disposed within the at least one pocket of the at least one pocket page.

9. The system of claim 8, wherein the display structure further includes a fold support stand.

10. A method of musical instruction, comprising:
providing a carrying case having colored makers stored in a first pocket, picks stored in a second pocket, an erasing cloth stored in a third pocket, a display board stored in a fourth pocket, a plurality of pocket pages held in the carrying case by a ring binder, the pocket pages having stored therein a plurality of chord glyphs;
removing the display board and at least a portion of the chord glyphs from the carrying case;
unfolding a support stand of the display board such that the display board is positioned in a substantially upright position; and
removably attaching the chord glyphs removed from the carrying case to a display surface of the display board such that each of the removably attached chord glyphs has a glyph imaging surface facing away from the display board.

11. The method of claim 10, further comprising:
writing musical information on a display surface of the display board.

12. The method of claim 11, wherein the pocket pages further have stored therein blank glyphs; and the method further comprising removing at least one blank glyph from the carrying case; writing a chord on the at least one blank glyph; and removably attaching the at least one blank glyph to the display surface of the display board.
